(19) United States
(12) Patent Application Publication
(10) Pub. No.: US 2025/0184085 A1
(43) Pub. Date: Jun. 5, 2025

(54) METHOD AND APPARATUS OF DETERMINING RESOURCES

(71) Applicant: Lenovo (Beijing) Limited, Beijing (CN)

(72) Inventors: Ran Yue, Beijing (CN); Lianhai Wu, Beijing (CN); Bingchao Liu, Beijing (CN); Jing Han, Beijing (CN); Min Xu, Beijing (CN)

(73) Assignee: Lenovo (Beijing) Limited, Beijing (CN)

(21) Appl. No.: 18/840,384

(22) PCT Filed: Feb. 22, 2022
(86) PCT No.: PCT/CN2022/077315

§ 371 Date: Aug. 21, 2024

(51) Int. Cl. H04L 5/00

(52) U.S. Cl. CPC H04L 5/0053; H04L 5/0064

(57) ABSTRACT

The present application relates to methods and apparatuses of determining resources. One embodiment of the present disclosure provides a UE, which includes: a transceiver; and a processor coupled with the transceiver, wherein the processor is configured to: determine whether there is one or more resource collisions among a set of resources used by a plurality of channels, wherein the plurality of channels are associated with different control resource set (CORESET) pool indexes; and determine one or more resources of the set of resources as one or more prioritized resources in response to there being one or more resource collisions.

### TECHNICAL FIELD

Embodiments of the present disclosure relate to wireless communication technology, and more particularly to methods and apparatuses of determining resources.

### BACKGROUND OF THE INVENTION

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

In a wireless communication system, a user equipment (UE) may transmit uplink (UL) data and/or signals on resources associated with different physical channels, such as physical uplink shared channel (PUSCH), physical uplink control channel (PUCCH), PUCCH scheduling request (SR), or the like. However, some resources may overlap at least in time domain. In other words, there might be resource collision among the resources for UL transmission.

Thus, there is a need of determining resources in a wireless communication system to solve the resource collision.

### SUMMARY

An embodiment of the present disclosure provides a UE, which includes: a transceiver; and a processor coupled with the transceiver, wherein the processor is configured to: determine whether there is one or more resource collisions among a set of resources used by a plurality of channels, wherein the plurality of channels are associated with different control resource set (CORESET) pool indexes; and determine one or more resources of the set of resources as one or more prioritized resources in response to there being one or more resource collisions.

In some embodiments, determining whether there is one or more resource collisions includes: for a first resource used by a first channel of the plurality of channels and a second resource used by a second channel of the plurality of channels, determining whether the first resource and the second resource at least partially overlap in at least one of time domain or frequency domain, wherein a CORESET pool index associated with the first channel is different from that associated with the second channel.

In some embodiments, in the case that the first resource and the second resource at least partially overlap in at least one of time domain or frequency domain, the processor is further configured to: determine there is no resource collision between the first resource and the second resource in response to at least one of the following: the first channel and the second channel being allowed to be transmitted simultaneously; the first channel and the second channel being a same type of channel; or an updated code rate of uplink data for a punctured channel of the first channel and the second channel being smaller than a threshold.

In some embodiments, in the case that the first resource and the second resource at least partially overlap in at least one of time domain or in frequency domain, the processor is further configured to: determine there is a resource collision between the first resource and the second resource in response to at least one of the following: the first channel and the second channel being not allowed to be transmitted simultaneously; the first channel and the second channel being different types of channels; or an updated code rate of uplink data for a punctured channel of the first channel and the second channel being higher than a threshold.

In some embodiments, the processor is further configured to: determine whether there is one or more resource collisions in an ascending order of at least one of a starting time or an end time of each resource; or determine whether there is one or more resource collisions within a duration, wherein the duration includes a time period, a number of resource collisions, or continuous resource collisions.

In some embodiments, determining whether there is one or more resource collisions includes: for each CORESET pool index, determining at least one resource as at least one CORESET pool-level prioritized resource among a sub-set of resources associated with the CORESET pool index, wherein the sub-set of resources is included in the set of resources; and determining one or more resources of all CORESET pool-level prioritized resources associated the different CORESET pool indexes as the one or more prioritized resources.

In some embodiments, in the case that there is a resource collision between a first resource used by a first channel of the plurality of channels and the second resource used by a second channel of the plurality of channels, the processor is further configured to: determine at least one prioritized resource from the first resource and the second resource based on at least one of the following: a first priority level of the first channel and a second priority level of the second channel; a rule indicating simultaneous transmission of channels associated with different CORESET pool indexes; or a first determined value of a first higher layer parameter for a first CORESET of the first channel and a second determined value of a second higher layer parameter for a second CORESET of the second channel; and determine the other resource of the first resource and the second resource as a de-prioritized resource in the case that one prioritized resource is determined.

In some embodiments, at least one prioritized resource includes at least one of the following: a resource used by a channel of the first channel and the second channel having a priority level higher than other channel of the first channel and the second channel; a resource used by a channel of the first channel and the second channel having a priority level lower than other channel of the first channel and the second channel in the case that the rule indicates simultaneous transmission of the first channel and the second channel is allowed; a resource associated with a value of the first determined value and the second determined value that is higher than other value of the first determined value and the second determined value; or a resource associated with a value of the first determined value and the second determined value that is lower than other value of the first determined value and the second determined value in the case that the rule indicates simultaneous transmission of the first channel and the second channel is allowed.

In some embodiments, a part of the de-prioritized resource overlapped with the prioritized resource or the whole de-prioritized resource is dropped, and the de-prioritized resource is not compared in following resource collisions.

In some embodiments, in response to there being at least one resource collision the set of resources, the processor is further configured to: determine a resource of the set of resources which is associated with a channel with a priority equal to or higher than any channel associated with other resources of the set of resources as a prioritized resource.

In some embodiments, in the case that there being more than one resource collision in the set of resources, the processor is further configured to: determine a first prioritized resource from the set of resources firstly; and determine a second prioritized resource from remaining resources of the set of resources, which is at least one of: a) according to the first prioritized resource, a previous prioritized resource, or UE implementation; b) based on a rule indicating simultaneous transmission of channels associated with different CORESET pool indexes; or c) associated with a channel with a priority equal to or higher than any channel associated with the remaining resources of the set of resources.

In some embodiments, in the case that there is a resource collision between a first resource used by a first channel of the plurality of channels and the second resource used by a second channel of the plurality of channels, and the first channel and the second channel have an identical priority level, the processor is further configured to: determine a prioritized resource of the first resource and the second resource based on: a first remaining packet delay budget (PDB) of data associated with the first resource and a second remaining PDB of data associated with the second resource; or a priority level of a flow carried on the first channel and a priority level of a flow carried on the second channel.

In some embodiments, determining whether there is one or more resource collisions includes: determining there is a resource collision in the case that UE capability is limited.

In some embodiments, a resource in the set of resources includes at least one of: an uplink grant for data transmission, resource in frequency domain, or a resource in time domain.

Another embodiment of the present disclosure provides a BS, which includes: a transceiver; and a processor coupled with the transceiver, wherein the processor is configured to: determine whether there is one or more resource collisions among a set of resources used by a plurality of channels, wherein the plurality of channels are associated with different control resource set (CORESET) pool indexes; and determine one or more resource of the set of resources as one or more prioritized resources in response to there is one or more resource collisions.

In some embodiments, determining whether there is one or more resource collisions includes: for a first resource used by a first channel of the plurality of channels and a second resource used by a second channel of the plurality of channels, determining whether the first resource and the second resource at least partially overlap in at least one of time domain or frequency domain, wherein a CORESET pool index associated with the first channel is different from that associated with the second channel.

In some embodiments, in the case that the first resource and the second resource at least partially overlap in at least one of time domain or frequency domain, the processor is further configured to: determine there is no resource collision between the first resource and the second resource in response to at least one of the following: the first channel and the second channel being allowed to be transmitted simultaneously; the first channel and the second channel being a same type of channel; or an updated code rate of uplink data for a punctured channel of the first channel and the second channel being smaller than a threshold.

In some embodiments, in the case that the first resource and the second resource at least partially overlap in at least one of time domain or in frequency domain, the processor is further configured to: determine there is a resource collision between the first resource and the second resource in response to at least one of the following: the first channel and the second channel being not allowed to be transmitted simultaneously; the first channel and the second channel being different types of channels; or an updated code rate of uplink data for a punctured channel of the first channel and the second channel being higher than a threshold.

In some embodiments, the processor is further configured to: determine whether there is one or more resource collisions in an ascending order of at least one of a starting time or an end time of each resource; or determine whether there is one or more resource collisions within a duration, wherein the duration includes a time period, a number of resource collisions, or continuous resource collisions.

In some embodiments, determining whether there is one or more resource collisions includes: for each CORESET pool index, determining at least one resource as at least one CORESET pool-level prioritized resource among a sub-set of resources associated with the CORESET pool index, wherein the sub-set of resources is included in the set of resources; and determining one or more resources of all CORESET pool-level prioritized resources associated the different CORESET pool indexes as the one or more prioritized resources.

In some embodiments, in the case that there is a resource collision between a first resource used by a first channel of the plurality of channels and the second resource used by a second channel of the plurality of channels, the processor is further configured to: determine at least one prioritized resource from the first resource and the second resource based on at least one of the following: a first priority level of the first channel and a second priority level of the second channel; a rule indicating simultaneous transmission of channels associated with different CORESET pool indexes; or a first higher layer parameter for a first CORESET of the first channel and a second higher layer parameter for a second CORESET of the second channel; and determine the other resource of the first resource and the second resource as a de-prioritized resource in the case that one prioritized resource is determined.

In some embodiments, the at least one prioritized resource includes at least one of the following: a resource used by a channel of the first channel and the second channel having a priority level higher than other channel of the first channel and the second channel; a resource used by a channel of the first channel and the second channel having a priority level lower than other channel of the first channel and the second channel in the case that the rule indicates simultaneous transmission of the first channel and the second channel is allowed; a resource associated with a value of the first determined value and the second determined value that is higher than other value of the first determined value and the second determined value; or a resource associated with a value of the first determined value and the second determined value that is lower than other value of the first determined value and the second determined value in the case that the rule indicates simultaneous transmission of the first channel and the second channel is allowed.

In some embodiments, in response to there being at least one resource collision the set of resources, the processor is further configured to: determine a resource of the set of resources which is associated with a channel with a priority equal to or higher than any channel associated with other resources of the set of resources as a prioritized resource.

In some embodiments, in the case that there being more than one resource collision in the set of resources, the processor is further configured to: determine a first prioritized resource from the set of resources firstly; and determine a second prioritized resource from remaining resources of the set of resources, which is at least one of: a) according to the first prioritized resource, a previous prioritized resource, or UE implementation; b) based on a rule indicating simultaneous transmission of channels associated with different CORESET pool indexes; or c) associated with a channel with a priority equal to or higher than any channel associated with the remaining resources of the set of resources.

In some embodiments, in the case that there is a resource collision between a first resource used by a first channel of the plurality of channels and the second resource used by a second channel of the plurality of channels, and the first channel and the second channel have an identical priority level, the processor is further configured to: determine a prioritized resource of the first resource and the second resource based on: a remaining PDB of data associated with the first resource and a remaining PDB of data associated with the second resource; or a priority of a flow carried on the first channel and a priority of a flow carried on the second channel.

In some embodiments, determining whether there is one or more resource collisions includes: determining there is a resource collision in the case that UE capability is limited.

In some embodiments, a resource in the set of resources includes at least one of: an uplink grant for data transmission, resource in frequency domain, or a resource in time domain.

Still another embodiment of the present disclosure provides a method performed by UE, which includes: determining whether there is one or more resource collisions among a set of resources used by a plurality of channels, wherein the plurality of channels are associated with different CORESET pool indexes; and determining one or more resources of the set of resources as one or more prioritized resources in response to there being one or more resource collisions.

In some embodiments, determining whether there is one or more resource collisions includes: for a first resource used by a first channel of the plurality of channels and a second resource used by a second channel of the plurality of channels, determining whether the first resource and the second resource at least partially overlap in at least one of time domain or frequency domain, wherein a CORESET pool index associated with the first channel is different from that associated with the second channel.

In some embodiments, in the case that the first resource and the second resource at least partially overlap in at least one of time domain or frequency domain, the method further includes: determining there is no resource collision between the first resource and the second resource in response to at least one of the following: the first channel and the second channel being allowed to be transmitted simultaneously; the first channel and the second channel being a same type of channel; or an updated code rate of uplink data for a punctured channel of the first channel and the second channel being smaller than a threshold.

In some embodiments, in the case that the first resource and the second resource at least partially overlap in at least one of time domain or in frequency domain, the method further includes: determining there is a resource collision between the first resource and the second resource in response to at least one of the following: the first channel and the second channel being not allowed to be transmitted simultaneously; the first channel and the second channel being different types of channels; or an updated code rate of uplink data for a punctured channel of the first channel and the second channel being higher than a threshold.

In some embodiments, the method further includes: determining whether there is one or more resource collisions in an ascending order of at least one of a starting time or an end time of each resource; or determining whether there is one or more resource collisions within a duration, wherein the duration includes a time period, a number of resource collisions, or continuous resource collisions.

In some embodiments, determining whether there is one or more resource collisions further includes: for each CORESET pool index, determining at least one resource as at least one CORESET pool-level prioritized resource among a sub-set of resources associated with the CORESET pool index, wherein the sub-set of resources is included in the set of resources; and determining one or more resources of all CORESET pool-level prioritized resources associated the different CORESET pool indexes as the one or more prioritized resources.

In some embodiments, in the case that there is a resource collision between a first resource used by a first channel of the plurality of channels and the second resource used by a second channel of the plurality of channels, the method further includes: determining at least one prioritized resource from the first resource and the second resource based on at least one of the following: a first priority level of the first channel and a second priority level of the second channel; a rule indicating simultaneous transmission of channels associated with different CORESET pool indexes; or a first higher layer parameter for a first CORESET of the first channel and a second higher layer parameter for a second CORESET of the second channel; and determining the other resource of the first resource and the second resource as a de-prioritized resource in the case that one prioritized resource is determined.

In some embodiments, the at least one prioritized resource includes at least one of the following: a resource used by a channel of the first channel and the second channel having a priority level higher than other channel of the first channel and the second channel; a resource used by a channel of the first channel and the second channel having a priority level lower than other channel of the first channel and the second channel in the case that the rule indicates simultaneous transmission of the first channel and the second channel is allowed; a resource associated with a value of the first determined value and the second determined value that is higher than other value of the first determined value and the second determined value; or a resource associated with a value of the first determined value and the second determined value that is lower than other value of the first determined value and the second determined value in the case that the rule indicates simultaneous transmission of the first channel and the second channel is allowed.

In some embodiments, a part of the de-prioritized resource overlapped with the prioritized resource or the whole de-prioritized resource is dropped, and the de-prioritized resource is not compared in following resource collisions.

In some embodiments, in response to there being at least one resource collision the set of resources, the method further includes: determining a resource of the set of resources which is associated with a channel with a priority equal to or higher than any channel associated with other resources of the set of resources as a prioritized resource.

In some embodiments, in the case that there being more than one resource collision in the set of resources, the method further includes: determining a first prioritized resource from the set of resources firstly; and determining a second prioritized resource from remaining resources of the set of resources, which is at least one of: a) according to the first prioritized resource, a previous prioritized resource, or UE implementation; b) based on a rule indicating simultaneous transmission of channels associated with different CORESET pool indexes; or c) associated with a channel with a priority equal to or higher than any channel associated with the remaining resources of the set of resources.

In some embodiments, in the case that there is a resource collision between a first resource used by a first channel of the plurality of channels and the second resource used by a second channel of the plurality of channels, and the first channel and the second channel have an identical priority level, the method further includes: determining a prioritized resource of the first resource and the second resource based on: a remaining PDB of data associated with the first resource and a remaining PDB of data associated with the second resource; or a priority of a flow carried on the first channel and a priority of a flow carried on the second channel.

In some embodiments, determining whether there is one or more resource collisions includes: determining there is a resource collision in the case that UE capability is limited.

In some embodiments, a resource in the set of resources includes at least one of: an uplink grant for data transmission, resource in frequency domain, or a resource in time domain.

Yet another embodiment of the present disclosure provides a method performed by a BS, which includes: determining whether there is one or more resource collisions among a set of resources used by a plurality of channels, wherein the plurality of channels are associated with different CORESET pool indexes; and determining one or more resource of the set of resources as one or more prioritized resources in response to there is one or more resource collisions.

In some embodiments, determining whether there is one or more resource collisions includes: for a first resource used by a first channel of the plurality of channels and a second resource used by a second channel of the plurality of channels, determining whether the first resource and the second resource at least partially overlap in at least one of time domain or frequency domain, wherein a CORESET pool index associated with the first channel is different from that associated with the second channel.

In some embodiments, in the case that the first resource and the second resource at least partially overlap in at least one of time domain or frequency domain, the method further includes: determining there is no resource collision between the first resource and the second resource in response to at least one of the following: the first channel and the second channel being allowed to be transmitted simultaneously; the first channel and the second channel being a same type of channel; or an updated code rate of uplink data for a punctured channel of the first channel and the second channel being smaller than a threshold.

In some embodiments, in the case that the first resource and the second resource at least partially overlap in at least one of time domain or in frequency domain, the method further includes: determining there is a resource collision between the first resource and the second resource in response to at least one of the following: the first channel and the second channel being not allowed to be transmitted simultaneously; the first channel and the second channel being different types of channels; or an updated code rate of uplink data for a punctured channel of the first channel and the second channel being higher than a threshold.

In some embodiments, the method further includes: determining whether there is one or more resource collisions in an ascending order of at least one of a starting time or an end time of each resource; or determining whether there is one or more resource collisions within a duration, wherein the duration includes a time period, a number of resource collisions, or continuous resource collisions.

In some embodiments, determining whether there is one or more resource collisions includes: for each CORESET pool index, determining at least one resource as at least one CORESET pool-level prioritized resource among a sub-set of resources associated with the CORESET pool index, wherein the sub-set of resources is included in the set of resources; and determining one or more resources of all CORESET pool-level prioritized resources associated the different CORESET pool indexes as the one or more prioritized resources.

In some embodiments, in the case that there is a resource collision between a first resource used by a first channel of the plurality of channels and the second resource used by a second channel of the plurality of channels, the method further includes: determining at least one prioritized resource from the first resource and the second resource based on at least one of the following: a first priority level of the first channel and a second priority level of the second channel; a rule indicating simultaneous transmission of channels associated with different CORESET pool indexes; or a first higher layer parameter for a first CORESET of the first channel and a second higher layer parameter for a second CORESET of the second channel; and determining the other resource of the first resource and the second resource as a de-prioritized resource in the case that one prioritized resource is determined.

In some embodiments, the at least one prioritized resource includes at least one of the following: a resource used by a channel of the first channel and the second channel having a priority level higher than other channel of the first channel and the second channel; a resource used by a channel of the first channel and the second channel having a priority level lower than other channel of the first channel and the second channel in the case that the rule indicates simultaneous transmission of the first channel and the second channel is allowed; a resource associated with a value of the first determined value and the second determined value that is higher than other value of the first determined value and the second determined value; or a resource associated with a value of the first determined value and the second determined value that is lower than other value of the first determined value and the second determined value in the case that the rule indicates simultaneous transmission of the first channel and the second channel is allowed.

In some embodiments, in response to there being at least one resource collision the set of resources, the method further includes: determining a resource of the set of resources which is associated with a channel with a priority equal to or higher than any channel associated with other resources of the set of resources as a prioritized resource.

In some embodiments, in the case that there being more than one resource collision in the set of resources, the method further includes: determining a first prioritized resource from the set of resources firstly; and determining a second prioritized resource from remaining resources of the set of resources, which is at least one of: a) according to the first prioritized resource, a previous prioritized resource, or UE implementation; b) based on a rule indicating simultaneous transmission of channels associated with different CORESET pool indexes; or c) associated with a channel with a priority equal to or higher than any channel associated with the remaining resources of the set of resources.

In some embodiments, in the case that there is a resource collision between a first resource used by a first channel of the plurality of channels and the second resource used by a second channel of the plurality of channels, and the first channel and the second channel have an identical priority level, the method further includes: determining a prioritized resource of the first resource and the second resource based on: a remaining PDB of data associated with the first resource and a remaining PDB of data associated with the second resource; or a priority of a flow carried on the first channel and a priority of a flow carried on the second channel.

In some embodiments, determining whether there is one or more resource collisions includes: determining there is a resource collision in the case that UE capability is limited.

In some embodiments, a resource in the set of resources includes at least one of: an uplink grant for data transmission, resource in frequency domain, or a resource in time domain.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present disclosure.

FIG. 2 illustrates an exemplary resource collision scenario according to some embodiments of the present disclosure.

FIGS. 3A-3C respectively illustrate exemplary resource collision scenarios according to some embodiments of the present disclosure.

FIGS. 4A-4C respectively illustrate exemplary resources determination according to some embodiments of the present disclosure.

FIG. 5 illustrates a flow chart of an exemplary procedure of resources determination according to some embodiments of the present disclosure.

FIG. 6 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP LTE, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

FIG. 1 illustrates a schematic diagram of a wireless communication system 100 in accordance with some embodiments of the present disclosure.

As shown in FIG. 1, a wireless communication system 100 may include some UEs 101 (e.g., the first UE 101a and the second UE 101b) and a base station (BS) 102. Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BS 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with the 5G NR of the 3GPP protocol. For example, BS 102 may transmit data using an OFDM modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

The UE may perform UL transmission to the BS, for example, the UE may perform PUCCH transmission, PUSCH transmission, etc. The UE may use one panel to perform the UL transmission, and the panel of the UE may be identified by the following parameters:
1. panel identity (ID) or panel index;
2. link ID or link index;
3. CORESET pool ID, CORESET pool index, or CORESETPoolIndex;
4. beam ID or beam index,
5. beam set ID or beam set index, or
6. RS set ID or RS set index.

Correspondingly, the BS may use a transmit-receive point (TRP) to receive the UL transmission, and the TRP of the BS may be identified by the following parameters:
1. TRP ID or TRP index;
2. link ID or link index;
3. CORESET pool ID, CORESET pool index, or CORESETPoolIndex;
4. beam ID or beam index,
5. beam set ID or beam set index, or
6. RS set ID or RS set index.

In some cases, the resource for one UL transmission may overlap with the resource for another UL transmission, e.g., in at least one of time domain and frequency domain, that is, a resource collision happens.

When there is only one panel (or TRP, beam, beam set, RS set, CORESET pool, or the like) used for UL transmission at a slot, the potential resource collisions and the comparison of the resource priorities are only considered in time domain.

In embodiments of the present disclosure, the hardware capabilities of a UE may include two or more panels, two or more receiving (Rx) chains, two or more transmitting (Tx) chains, two or more radio frequency (RF) chains, two or more beams, two or more links, or the like, to perform the UL transmission. Accordingly, the resource collisions may take place across different panels.

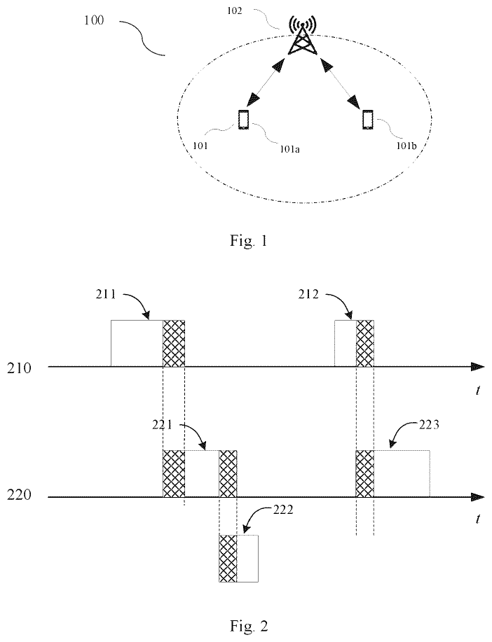

FIG. 2 illustrates an exemplary resource collision scenario according to some embodiments of the present disclosure.

Two horizontal axes are shown in FIG. 2, wherein one axis is the first time axis related to the first panel 210 of a UE, and the other axis is the second time axis related to the second panel 220 of the UE. UL transmission resource 211 and UL transmission resource 212 may be associated with the first panel 210, wherein the UL transmission resource 211 may be used for PUCCH-SR transmission, and UL transmission 212 may be another PUCCH-SR transmission. UL transmission resource 221, UL transmission resource 222, and UL transmission resource 223 may be associated with the second panel 220, wherein the UL transmission resource 221 may be used for configured grant (CG)-PUSCH transmission, UL transmission resource 222 may be used for PUCCH-SR transmission, and UL transmission 223 may be used for another CG-PUSCH transmission. In some other embodiments, the UL transmission resources may be used for other channels, such as SR, uplink control information (UCI), or any other control information which will not be multiplexed on the overlapped resources.

In FIG. 2, the UL transmission resource 211 overlaps with the UL transmission resource 221 in time domain, the UL transmission resource 221 also overlaps with the UL transmission resource 222 in time domain, and the UL transmission resource 212 overlaps with the UL transmission resource 223 in time domain. The blocks with cross lines in FIG. 2 represent the overlapped part among the resources. As can be seen, the resource collisions may include the resource collision on the same panel, and also include the resource collision cross different panels.

For the resource collisions on the same panel, the UE may be configured with logical channel ((LCH) based prioritization (e.g., lch-basedPrioritization). The UE may compare the priority associated with the logical channels, and then determine a prioritized resource which is associated with a channel has higher priority. In the present disclosure, the term “priority” may have the same meaning as the term “priority level”. Correspondingly, the “priority” of the logical channel has the same meaning as the “priority level” of the logical channel, and the “priority” of the resource has the same meaning as the “priority level” of the resource.

For example, supposing that the UL transmission resource 221 associated with the second panel 220 is used for PUSCH transmission transmitted on CG, and PUSCH has the first priority level, and the UL transmission resource 222 associated with the second panel 220 is used for PUCCH-SR transmission, and PUCCH-SR has the second priority level.

In the case that the first priority level is higher than the second priority level, the UL transmission resource 221 associated with the first priority level is considered as a prioritized resource, while the UL transmission resource 222 associated with the second priority level is considered as a de-prioritized resource. Similarly, in the case that the first priority level is lower than the second priority level, the UL transmission resource 221 associated with the first priority level is considered as a de-prioritized resource, while the UL transmission resource 222 associated with the second priority level is considered as a prioritized resource.

In the case that the first priority level is equal to the second priority, which resource is considered as the prioritized resource may be determined based on UE implementation, or further action(s) may be taken.

Similarly, when there is a resource collision across panels or TRPs, determining the prioritized resource(s) is needed. For the resource collisions cross two or more panels, embodiments of the present disclosure propose several solutions of determining the prioritized resource(s) as follows.

It is supposed that UL data (or UL packet) for the two or more channels may be transmitted on two or more resources across two or more panels at the UE side on the same component carrier (CC), or on different CCs. Correspondingly, at the BS side, UL data for the two or more channels may be received on two or more resources across two or more TRPs on the same CC or different CCs. The resources used by the two or more channels may be overlapped in time domain only, in frequency domain only, or in both time domain and frequency domain. Hereinafter, a resource collision relates to two resources having overlapped part in time domain, in frequency domain, or in both time domain and frequency domain, across different panels or different TRPs, and furthermore, the two overlapped resources cannot be transmitted at the same time. This transmission may be also referred to as overlapped resources transmission. In some embodiments, UL data for each channel may be transmitted on a resource on a corresponding panel; in some other embodiments, UL data for two or more channels may be transmitted on two or more resources on one panel among the two or more panels; and in still other embodiments, UL data for two or more channels may be transmitted on two or more resources on two panels among the two or more panels, etc.

Whether there are resource collision(s) among the two or more resources are determined in the following scenarios:

### Scenario 1

The types of the two or more channels across two or more panels are the same. For example, the two or more channels may all be PUCCH, or PUSCH. In this case, although the resources used by the two or more channels may be overlapped in at least one of time domain and frequency domain, i.e., time domain only, frequency domain only, or both time domain and frequency domain, these channels can be transmitted simultaneously across two or more panels, and they are not considered as overlapped resource transmission. In other words, there is no resource collision among these two or more resources.

The two or more channels transmitted across two or more panels may include at least two different types of channels. For example, two channels among the two or more channels may include: PUCCH and PUSCH, or other different types of physical channels, etc. In this case, if any two resources used by two different types of channels are overlapped, there is a resource collision between the two or more resources. The UE may need to determine prioritized resource(s) out of the two or more resources.

### Scenario 2

A rule indicating simultaneous transmission across different panels (or UL receptions across different TPRs, hereafter the same) is specified. The rule may indicate that some channels are allowed to be transmitted on different panels even if the resources for these channels are overlapped across different panels in at least one of time domain and frequency domain, i.e., time domain only, frequency domain only, or both time domain and frequency domain. The rule may be configured by network, or by reconfiguration, or by 3GPP specification. At the BS side, the BS may also be configured with a similar rule.

For example, the rule may indicate that:
1. PUSCH and PUSCH are allowed to be transmitted across two panels in the same CC while the resources for the two channels are overlapped across two panels in at least one of time domain and frequency domain, i.e., time domain only, frequency domain only, or both time domain and frequency domain;
2. PUCCH and PUCCH are allowed to be transmitted across two panels in the same CC while the resources for the two channels are overlapped across two panels in at least one of time domain and frequency domain, i.e., time domain only, frequency domain only, or both time domain and frequency domain;
3. PUSCH and PUCCH are allowed to be transmitted across two panels in the same CC while the resources for the two channels are overlapped across two panels in at least one of time domain and frequency domain, i.e., time domain only, frequency domain only, or both time domain and frequency domain;
4. Physical random access channel (PRACH) and PRACH are allowed to be transmitted across two panels in the same CC while the resources for the two channels are overlapped across two panels in at least one of time domain and frequency domain, i.e., time domain only, frequency domain only, or both time domain and frequency domain;
5. One or more types of physical channels among PUSCH, PUCCH, and PRACH are allowed to be transmitted across two or more panels in the same CC while the resources for the at least one or more types of channels are overlapped across two or more different panels in at least one of time domain and frequency domain, i.e., time domain only, frequency domain only, or both time domain and frequency domain; or
6. other configurations.

It should be noted that the above examples are exemplary, and the solutions of the present disclosure also apply to other simultaneous transmission across different panels.

Based on the above rule(s), when UL data (or UL packet) for two or more different channels are transmitted on resources across two or more panels, and the two or more channels are allowed to be transmitted simultaneously across different panels according to the above rule, then there is no resource collision among the resources. When the channels are not allowed to be transmitted simultaneously across different panels according to the above rule, then there is resource collision(s) among the resources.

### Scenario 3

A threshold for simultaneous transmission may be specified. The threshold may be a threshold of code rate. The code rate may be associated with the SR transmission.

For two resources used by the two channels overlapped in at least one of time domain and frequency domain, i.e., time domain only, frequency domain only, or both time domain and frequency domain, a resource for the channel with smaller priority level is punctured. The code rate may be calculated based on the punctured resource, and an updated code rate is obtained. If the updated code rate is larger than the threshold, and there is resource collision between the two resources. If the updated code rate is smaller or less than the threshold, the punctured channel shall be transmitted, and there is no resource collision between the two resources. In some embodiments, when there is resource collision between the two resources due to the updated code rate being lower than the threshold, both the resource for the channel with the higher priority level and the resource for the channel with the lower priority level are prioritized. When there is resource collision between the two resources due to the updated code rate being higher than the threshold, the resource for the channel with the higher priority level is prioritized. Alternatively, the resource for the channel which is the same channel as the first prioritized channel or the previous prioritized channel is prioritized. Alternatively, when there is resource collision between the two resources due to the updated code rate being higher than the threshold, the resource for the channel with the lower priority level is prioritized.

In some embodiments, PUCCH is associated with a high priority level than that of PUSCH, and the puncture operation is performed on PUSCH. In some other embodiments, an indicator may be transmitted to the UE, to indicate that a channel, e.g. PUSCH, is allowed to be punctured.

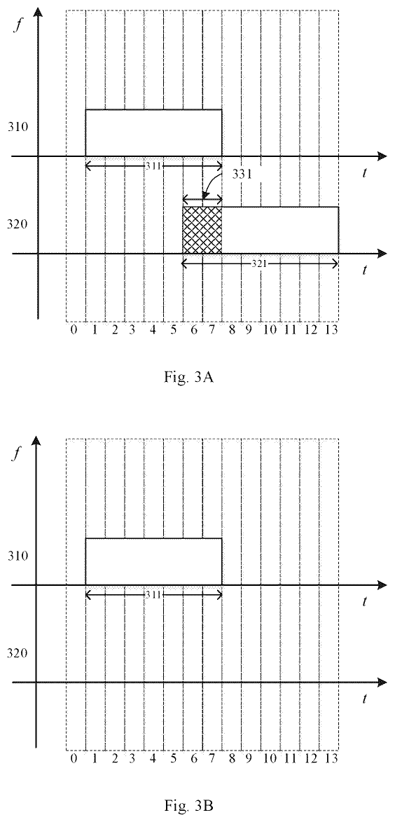

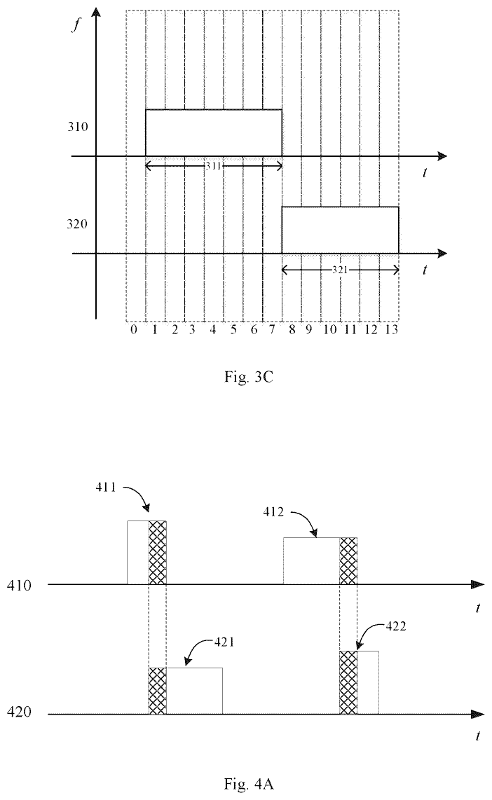

FIGS. 3A-3C respectively illustrate exemplary resource collision scenarios according to some embodiments of the present disclosure.

Two time axes are shown in FIG. 3A, wherein the first time axis relates to the first panel 310 of the UE, and the second time axis relates to the second panel 320 of the UE. UL transmission resource 311 may be associated with the first panel 210, and UL transmission resource 321 may be associated with the second panel 320. As shown in FIG. 3A, UL transmission resource 311 (resource 311) is within symbol #1 to symbol #7 in a slot, and UL transmission resource 321 (resource 321) is within symbol #6 to symbol #13 in the same slot, and the two resources overlap in symbol #6 and symbol #7 in time domain. Furthermore, according to the rule indicating simultaneous transmission, the first channel that uses UL transmission resource 311 and the second channel that uses UL transmission resource 321 are not allowed to be transmitted simultaneously. The resource 311 may be used for PUCCH, and the resource 321 may be used for PUSCH.

For example, it is supposed that PUSCH has a lower priority level, and UL transmission resource 321 is punctured. In other words, symbol #6 and symbol #7 in UL transmission resource 321 are punctured, that is, dropping the part of PUSCH in symbol #6 and symbol #7, the data supposed to be transmitted from symbol #6 to symbol #13 may be transmitted in symbols #8 to #13. With less symbols, the UE may calculate an updated code rate, which may be increased compared with the original code rate. If the updated code rate is less than the threshold, the UE can still transmit the data in the punctured UL transmission resource 321, and there is no resource collision between UL transmission resource 311 and UL transmission resource 321. Or the resource collision is resolved between UL transmission resource 311 and UL transmission resource 321.

If the updated code rate is larger than the threshold, the UE cannot transmit the data in the punctured UL transmission resource 321, and there is a resource collision between UL transmission resource 311 and UL transmission resource 321. As shown in FIG. 3B, the whole PUSCH is dropped and/or the PUSCH is de-prioritized. If it is smaller than the threshold, the punctured PUSCH shall be transmitted. As shown in FIG. 3C, the punctured PUSCH is transmitted.

It should be noted that in all the above scenarios, when there is no resource collision but the UE capability, e.g., the UL transmission power, or UE RF chain(s) of the UE, is limited (or, in other words, the UE cannot perform the simultaneous transmission due to limited UE capability), the UE may still need to determine prioritized resource of the two or more resources for the two or more channels.

Similarly, at BS side, the BS may also determine whether there are resource collision(s) among the resources across different TRPs in a similar fashion as the UE does. For example, the BS may determine whether there are resource collision(s) among the resources as described in scenario 1. Specifically, the BS may determine whether there are resource collision(s) among the resources based on dynamic scheduling and/or configured grant for the channels. In the dynamic scheduling or the configured grant, resource information (e.g. the frequency domain, time domain, or spatial domain information) and/or the panel information (or the TRP, the beam, the beam set, the CORESET pool, etc.) associated with the resource may be included, and the BS may determine whether there are resource collision(s) among the resources at least based on one of the resource information or the panel information. Further, the BS may identify (or determine) the UE's determination for the prioritized resource(s) by detecting or receiving the corresponding resource(s).

The BS may determine whether there are resource collision(s) among the resources across different TRPs based on the rule indicating simultaneous transmission across different TRPs as described in scenario 2; or determine whether there are resource collision(s) among the resources across different TRP based on the threshold for simultaneous transmission as described in scenario 3.

Based on the above rules of determining the resource collision, the present disclosure proposes some solutions of determining prioritized resource(s) when there are resource collisions. Hereinafter in the present disclosure, determining prioritized resource(s) may include determining at least one of prioritized resource(s) and de-prioritized resource(s). The UE may take the following options:

### Option 1

The UE may determine whether there is one or more resource collisions in an ascending order of at least one of a starting time or an end time of each resource. In the case that there is one or more resource collisions, the UE then determines at least one of the prioritized resource(s) and de-prioritized resource(s) among the overlapped resources. Determining the prioritized resource(s) and de-prioritized resource(s) may be in the order of collision occurrence, for example, in the ascending order of the time point of the collision occurrence.

Specifically, the UE may be configured with logical channel based prioritization (e.g., lch-basedPrioritization), and the determination may be based on the priority levels of the channels that are to be transmitted on the overlapped resources. For example, there are two channels, i.e., the first channel and the second channel. The first channel is associated with the first priority level; and the second channel is associated with the second. There is a resource collision between the two resources for the two channels, and the first priority level associated with the first channel and the second priority level associated with the second channel are compared. If the first priority level is higher than the second priority level, which means the first channel has higher priority level than that of the second channel, then the first resource used by the first channel is determined as the prioritized resource, and the second resource used by the second channel is determined as the de-prioritized resource. If the first priority level is lower than the second priority level, which means the first channel has lower priority level than that of the second channel, then the first resource used by the first channel is determined as the de-prioritized resource, and the second resource used by the second channel is determined as the prioritized resource. Once a resource is considered as the de-prioritized resource, it is not considered for the further comparison.

In this option, the resource for the first channel and the resource for the second channel may be associated with the same panel, or may be associated with different panels.

Alternatively, in addition to comparing the priority level associated with the channels, and determining prioritized resource with higher priority level, the UE may detect the value of a higher layer parameter for different CORESET, and determine prioritized resource with higher detected value of the higher layer parameter. For example, the higher layer parameter may be the reference signal receiving power (RSRP) of the synchronization signal and physical broadcast channel (PBCH) block (SSB). The UE determines the first value of the RSRP SSB for a first CORESET, and determines the second value of RSRP SSB for the second CORESET, and select the higher one between the first value and the second value. As indicated above, the panel of the UE may be identified the CORESET index, and based on the determined CORESET index, the UE determines the corresponding panel, and determines the resource associated with the panel as the prioritized resource, and the other one as the de-prioritized resource.

Referring to FIG. 2, assuming resource 211 used by a channel having a priority level with the value of P₂₁₁, resource 212 used by a channel having a priority level with the value of P₂₁₂, resource 221 used by a channel having a priority level with the value of P₂₂₁, resource 222 used by a channel having a priority level with the value of P₂₂₂, and resource 223 used by a channel having a priority level with the value of P₂₂₃.

According to the ascending order of collision occurrence in time domain, for the first collision, the UE compares the priority level of the channel associated with resource 211 and the priority level of the channel associated with resource 221, i.e. the UE compares the value of P₂₁₁ and P₂₂₁, and suppose P₂₁₁ is higher than P₂₂₁, then resource 211 is considered as the prioritized resource, and resource 221 is considered as the de-prioritized resource. Since resource 221 is considered as the de-prioritized resource, it is not considered for further comparison. In other words, although there is a resource collision between resource 221 and resource 222, since resource 221 is no longer considered for further comparison, resource 222 is considered as the prioritized resource if there is no other collision with resource 222, no matter whether the priority level with the value of P₂₂₂ is higher than or lower than the priority level with the value of P₂₂₁.

Similarly, for resource 212 and resource 223, the UE compares the priority level of the channel associated with resource 212 and the priority level of the channel associated with resource 223, i.e. the UE compares the value of P₂₁₂ and P₂₂₃, assuming that P₂₂₃ is higher, then resource 223 is considered as the prioritized resource, and resource 212 is considered as the de-prioritized resource.

In option 1, the UE determines the prioritized resources include resource 211, resource 222, and resource 223.

### Option 2

In option 2, the UE performs the determination of prioritized resource(s) within a duration. The duration may be a time period, or a number of resource collisions, or continuous resource collisions.

Referring to FIG. 2, in one embodiment, the time period may include all the five resources, the UE performs the determination of prioritized resource(s) among the five resources, i.e. resource 211, resource 221, resource 222, resource 212, and resource 223. In another embodiment, the number of collisions may include four resource collisions, and the UE may perform the determination of prioritized resource(s) among the first four resources, i.e. resource 211, resource 221, resource 222, and resource 212, wherein there are four resource collisions among them. In other embodiment, the continuous resource collisions in FIG. 2 may include the first resource collision and the second resource collision, and the UE may perform the determination of prioritized resource(s) among the first three resources, i.e. resource 211, resource 221, and resource 222.

Within the duration, the UE may first perform intra-panel determination of prioritized resource(s), in other words, the UE may perform the determination of prioritized resource(s) for each panel first. The UE may determine the prioritized resource(s) and de-prioritized resource(s) for each panel based on the priority levels of the channels, in a similar way as described in option 1, and details are omitted here.

After the intra-panel determination, the UE determines the prioritized resource(s) and de-prioritized resource(s) for each panel. In the present disclosure, the resource(s) and de-prioritized resource(s) for each panel may be referred to as panel-level prioritized resource(s) and panel-level de-prioritized resource(s), link-level prioritized resource(s) and link-level de-prioritized resource(s), CORESET pool-level prioritized resource(s) and CORESET pool-level de-prioritized resource(s), beam-level prioritized resource(s) and beam-level de-prioritized resource(s), beam set-level prioritized resource(s) and beam set-level de-prioritized resource(s), RS set-level prioritized resource(s) and RS set-level de-prioritized resource(s), or the like.

The UE then performs inter-panel comparison among the panel-level prioritized resource(s) of each panel based on at least one of the following:
1. the rule indicating simultaneous transmission;
2. the threshold for simultaneous transmission; or
3. the priority levels of the channels that are to be transmitted on the overlapped resources.

Specifically, if two resources used by two channels have overlapped part in time domain, in frequency domain, or in both time domain and frequency domain across different panels, the UE may determine whether the two channels to be transmitted on the two resources are allowed to be transmitted simultaneously based on the rule indicating simultaneous transmission, if the rule indicates the two channels are allowed to be transmitted simultaneously across different panels (or different TRPs), there is no resource collision between the two resources from different panels, the UE determines both the two resources as the prioritized resources, otherwise, the UE compares the priority levels of the channels, and determines the resource associated with the channel having a higher priority as the prioritized resource, and the other resource as the de-prioritized resource

Alternatively, if two resources used by two channels have overlapped part in time domain, in frequency domain, or in both time domain and frequency domain across different panels, the UE may determine a parameter associated with the threshold for simultaneous transmission, to compare the value of the parameter with the threshold for simultaneous transmission.

If the value of the parameter is smaller than the threshold for simultaneous transmission, there is no resource collision between the two resources from different panels, the UE determines both the two resources as the prioritized resources, otherwise, the UE compares the priorities of the channels, and determines the resource which is associated with a channel has higher priority level as the prioritized resource, and the other resource as the de-prioritized resource.

Referring to FIG. 2, the UE first performs intra-panel determination of prioritized resource(s) for each panel. For panel 210, resource 211 and resource 212 does not overlap, thus both resources are determined as prioritized resources. The panel-level prioritized resources include resource 211 and resource 212.

For panel 220, resource 221 and resource 222 overlap in time domain, it is supposed that P₂₂₁ is higher than P₂₂₂, thus resource 221 is determined as prioritized resource, and resource 222 is determined as a de-prioritized resource. Resource 223 does not overlap with any resource, thus it is determined as a prioritized resource. The panel-level prioritized resources include resource 221 and resource 223.

The UE then performs inter-panel determination of prioritized resource(s). Resource 211 and resource 221 overlap in time domain, it is supposed that P₂₁₁ is higher than P₂₂₁, thus resource 211 is determined as prioritized resource, and resource 221 is determined as a de-prioritized resource. Resource 212 and resource 223 overlap in time domain, it is supposed that P₂₂₃ is higher than P₂₁₂, thus resource 223 is determined as prioritized resource, and resource 212 is determined as a de-prioritized resource.

In view of the above, the UE determines two prioritized resources, resource 211 and resource 223, and other resources are determined as de-prioritized resources.

### Option 3

In option 3, the UE performs the determination of prioritized resource(s) within a duration. The duration may be a time period, or a number of resource collisions, or continuous resource collisions.

The UE first determines all the resource collisions within the duration. For the first resource collision (or the last, or any other resource collision), the UE may determine the first prioritized resource and the first deprioritized resource (or two prioritized resources) based on the priority level associated with the channel that are to be transmitted on the resources in a similar fashion as described in option 1.

In the case there is another resource collision in addition to the first resource collision, the UE may select another prioritized resource according to the first prioritized resource (or the previous prioritized resource); for example, if the first prioritized resource (or the previous prioritized resource) is associated with PUCCH, the UE may select another prioritized resource which is also associated with PUCCH.

Alternatively, the UE may determine another prioritized resource that does not overlap with other resource.

Alternatively, the UE may determine another prioritized resource based on the rule indicating simultaneous transmission. For instance, if the first prioritized resource (or the previous prioritized resource) associated with PUCCH, and the rule indicates that simultaneous transmission between PUCCH and PUCCH across different panels is allowed, the UE may select another prioritized resource which is also used by PUCCH on a different panel.

Alternatively, the UE may determine another prioritized resource based on previous prioritized resource. For instance, if the previous prioritized resource is associated with PUSCH, such as a dynamic scheduling PUSCH, an uplink grant, and the UE may select another prioritized resource which is also used by PUSCH on a different panel; or the rule indicates that simultaneous transmission between PUSCH and PUCCH across different panels is allowed, the UE may select another prioritized resource which associated with PUCCH.

Still, the UE may determine another prioritized resource based on UE implementation.

In some other embodiments, if the UE is not configured with LCH based prioritization (e.g., lch-basedPrioritization), the dynamic grant is associated with the higher priority level than that of the configured grant by default, or vice versa, and the UE may determine prioritized resource based on the default priority levels and/or based on the rule indicating simultaneous transmission. Alternatively, the UE may receive indication indicating the priority levels associated with different channels, and the UE may determine prioritized resource based on the indicated priority levels and/or based on the rule indicating simultaneous transmission.

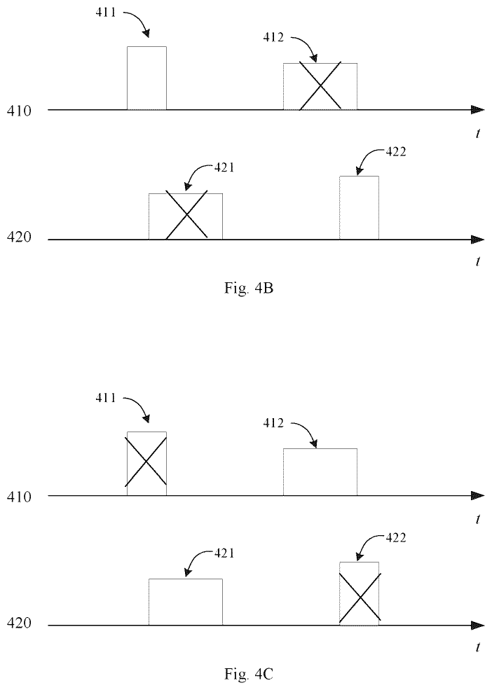

FIGS. 4A-4C respectively illustrate exemplary prioritized resources determination according to some embodiments of the present disclosure.

Two horizontal axes are shown in FIG. 4A, the first time axis relates to panel 410 of the UE, and the second time axis relates to panel 420 of the UE. UL transmission resource 411 and UL transmission resource 412 may be associated with panel 410, and UL transmission resource 421 and UL transmission resource 422 may be associated with panel 420.

Assuming resource 411 on panel 410 associated with PUSCH-SR with a priority level with the value of P₄₁₁, resource 412 on panel 410 associated with PUSCH with a priority level with the value of P₄₁₂, resource 421 on panel 420 associated with PUSCH with a priority level with the value of P₄₂₁, and resource 422 on panel 420 associated with PUSCH-SR with a priority level with the value of P₄₂₂. The relationship of the four priority levels may be: P₄₁₂>P₄₂₂>P₄₁₁>P₄₂₁.

In FIG. 4A, UL transmission resource 411 on panel 410 overlaps with UL transmission resource 421 on panel 220 in time domain, and UL transmission resource 412 on panel 410 overlaps with UL transmission resource 422 on panel 420 in time domain.

According to option 3, assuming the UE performs the determination of prioritized resource(s) within a duration including four resources, i.e., resource 411, resource 412, resource 421, and resource 422. The first resource collision is between resource 411 and resource 421, and the second resource collision is between resource 412 and resource 422.

For the first resource collision, because P₄₁₁>P₄₂₁, resource 411 is determined as the prioritized resource. For the second resource collision, the UE determines the prioritized resource according to the first prioritized resource. Resource 411 is used for PUCCH-SR transmission, resource 422 is also used for PUSCH-SR transmission, the UE then determines resource 422 as the second prioritized resource without considering that P₄₁₂ is larger than P₄₂₂. As shown in FIG. 4B, resource 411 and resource 422 are determined as the prioritized resources, and resource 412 and resource 421 are determined as the de-prioritized resources.

### Option 4

In option 4, the UE performs the determination of prioritized resource(s) within a duration. The duration may be a time period, or a number of resource collisions, the continuous resource collisions.

The UE first determines all the resource collisions within the duration. Among all the overlapped resources, the UE determines a resource that is associated with a channel with a priority level equal to or higher than the priority level of any channel as the first prioritized resource. Since there might be multiple channels that have the same priority, the UE may determine multiple resources that are associated with a channel with the same priority level, and the UE may determine the first one among the multiple resources or another one based on UE implementation.

After determining the first prioritized resource, the other prioritized resource is determined in a similar fashion as in the above option 3.

Referring to FIG. 4A, resource 412 is associated with PUSCH with the highest priority level, and the UE determines resource 412 as the first prioritized resource. Correspondingly, resource 422, which has a resource collision with resource 412, is determined as the de-prioritized resource. The UE then determines another prioritized resource based on the first prioritized resource. Resource 412 is associated with PUSCH, and resource 412 is also associated with PUSCH, the UE may determine resource 412 as the prioritized resource despite that P₄₁₁>P₄₂₁. As shown in FIG. 4C, resource 412 and resource 421 are determined as the prioritized resources, and resource 411 and resource 422 are determined as the de-prioritized resources.

In some other embodiments, there might be a resource collision between a first resource used by the first channel of the plurality of channels and the second resource used by the second channel of the plurality of channels, and the first channel and the second channel have an identical priority level. That is, the UE cannot determine which one is the prioritized resource by comparing the priority levels.

In this case, the UE may determine the first remaining packet delay budget (PDB) of the data associated with (or to be multiplexed or to be transmitted on) the first resource, and the second remaining PDB of data associated with the second resource. If the first remaining PDB is larger than the second remaining PDB, then the first resource is determined as the de-prioritized resource and the second resource is determined as the prioritized resource; or if the first remaining PDB is smaller than (or less than) the second remaining PDB, then the first resource is determined as the prioritized resource and the second resource is determined as the de-prioritized resource.

Alternatively, the UE may determine the priority level of a data flow carried on the first channel and a priority level of a data flow carried on the second channel, and determines the prioritized resource based on the higher priority level. The priority level of the resource may be determined by the highest priority among priorities of the data flows that are carried (or may be referred to as multiplexed, mapped, or filtered) on the logical channel.

Alternatively, the UE may determine the prioritized resource based on UE implementation if the first channel and the second channel have an identical priority level.

Correspondingly, after receiving the UL transmission on the prioritized resource, the BS may also determine the prioritized resource in a similar way as the UE does.

It should be noted that although some embodiments, options or scenarios in the present disclosure may relate to prioritized resources determination from two resources, it should be noted that the solutions of the present disclosure also apply to prioritized resources determination from more than two resources across more than two panels (or TRPs).

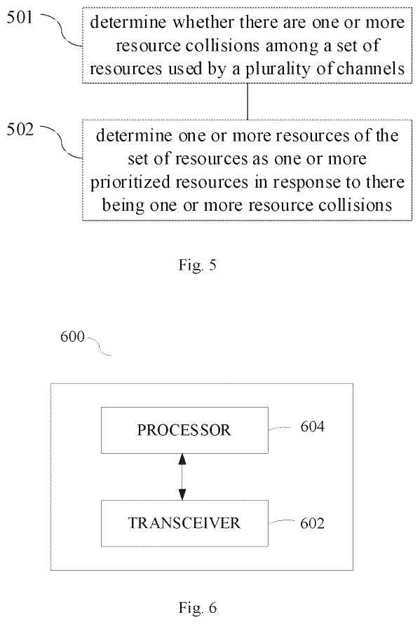

FIG. 5 illustrates a flow chart of an exemplary procedure of prioritized resources determination in accordance with some embodiments of the present disclosure.

Details described in all of the foregoing embodiments of the present disclosure are applicable for the embodiments shown in FIG. 5. In some examples, the procedure may be performed by a UE, for example, UE 101 in FIG. 1.

In operation 501, the UE may determine whether there is one or more resource collisions among a set of resources used by a plurality of channels, wherein the plurality of channels are associated with different CORESET pool. For example, in FIG. 4A, the UE may determine there are two resource collisions among the four resources used by a plurality of channels, and the plurality of channels are associated with different CORESET pool indexes, i.e. different panels. Correspondingly, at BS side, the UE may also determine whether there is one or more resource collisions among a set of resources used by a plurality of channels.

In operation 502, the UE may determine one or more resources of the set of resources as one or more prioritized resources in response to there being one or more resource collisions. Referring to FIG. 4B, the UE may determine two resources among the four resources as two prioritized resources. Correspondingly, at BS side, after receiving the UL data packets, the BS may also determine one or more resources of the set of resources as one or more prioritized resources in response to there being one or more resource collisions.

FIG. 6 illustrates a simplified block diagram of an exemplary apparatus according to some embodiments of the present disclosure.

As shown in FIG. 6, the apparatus 600 may include at least one processor 604 and at least one transceiver 602 coupled to the processor 604. The apparatus 600 may be a UE or a BS.

Although in this figure, elements such as the at least one transceiver 602 and processor 604 are described in the singular, the plural is contemplated unless a limitation to the singular is explicitly stated. In some embodiments of the present disclosure, the transceiver 602 may be divided into two devices, such as a receiving circuitry and a transmitting circuitry. In some embodiments of the present disclosure, the apparatus 600 may further include an input device, a memory, and/or other components.

In some embodiments of the present disclosure, the apparatus 600 may be a UE. The transceiver 602 and the processor 604 may interact with each other so as to perform the operations with respect to the UE described in FIGS. 1-5. In some embodiments of the present disclosure, the apparatus 600 may be a BS. The transceiver 602 and the processor 604 may interact with each other so as to perform the operations with respect to the BS described in FIGS. 1-5.

In some embodiments of the present disclosure, the apparatus 600 may further include at least one non-transitory computer-readable medium.

For example, in some embodiments of the present disclosure, the non-transitory computer-readable medium may have stored thereon computer-executable instructions to cause the processor 604 to implement the method with respect to the UE as described above. For example, the computer-executable instructions, when executed, cause the processor 604 interacting with transceiver 602 to perform the operations with respect to the UE described in FIGS. 1-5.

In some embodiments of the present disclosure, the non-transitory computer-readable medium may have stored thereon computer-executable instructions to cause the processor 604 to implement the method with respect to the BS as described above. For example, the computer-executable instructions, when executed, cause the processor 604 interacting with transceiver 602 to perform the operations with respect to the BS described in FIGS. 1-5.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “including.”

What is claimed is:

1. A user equipment (UE) for wireless communication, comprising:
at least one memory; and
at least one processor coupled with the at least one memory and configured to cause the UE to:
determine whether there are one or more resource collisions among a set of resources used by a plurality of channels, wherein the plurality of channels are associated with different control resource set (CORESET) pool indexes; and
determine one or more resources of the set of resources as one or more prioritized resources in response to there being one or more resource collisions.

2. The UE of claim 1, wherein to determine whether there are one or more resource collisions, the at least one processor is configured to cause the UE to:
determine, for a first resource used by a first channel of the plurality of channels and a second resource used by a second channel of the plurality of channels, whether the first resource and the second resource at least partially overlap in at least one of time domain or frequency domain, wherein a CORESET pool index associated with the first channel is different from that associated with the second channel.

3. The UE of claim 2, wherein in a case that the first resource and the second resource at least partially overlap in at least one of time domain or frequency domain, the at least one processor is further configured to cause the UE to:
determine there is no resource collision between the first resource and the second resource in response to at least one of:
the first channel and the second channel being allowed to be transmitted simultaneously;
the first channel and the second channel being a same type of channel; or
an updated code rate of uplink data for a punctured channel of the first channel and the second channel being smaller than a threshold.

2. The UE of claim 2, wherein in a case that the first resource and the second resource at least partially overlap in at least one of time domain or frequency domain, the at least one processor is further configured to cause the UE to:
determine there is a resource collision between the first resource and the second resource in response to at least one of:
the first channel and the second channel being not allowed to be transmitted simultaneously;
the first channel and the second channel being different types of channels; or
an updated code rate of uplink data for a punctured channel of the first channel and the second channel being higher than a threshold.

5. The UE of claim 1, wherein the at least one processor is further configured to cause the UE to one or more of:
determine whether there is one or more resource collisions in an ascending order of at least one of a starting time or an end time of each resource; or
determine whether there is one or more resource collisions within a duration, wherein the duration includes a time period, a number of resource collisions, or continuous resource collisions.

6. The UE of claim 1, wherein to determine, whether there are one or more resource collisions, the at least one processor is configured to cause the UE to:
determine, for each CORESET pool index, at least one resource as at least one CORESET pool-level prioritized resource among a sub-set of resources associated with the CORESET pool index, wherein the sub-set of resources is included in the set of resources; and
determine one or more resources of all CORESET pool-level prioritized resources associated the different CORESET pool indexes as the one or more prioritized resources.

7. The UE of claim 1, wherein in a case that there is a resource collision between a first resource used by a first channel of the plurality of channels and a second resource used by a second channel of the plurality of channels, the at least one processor is further configured to cause the UE to:
determine at least one prioritized resource from the first resource and the second resource based on at least one of:
a first priority level of the first channel and a second priority level of the second channel;
a rule indicating simultaneous transmission of channels associated with different CORESET pool indexes; or
a first determined value of a first higher layer parameter for a first CORESET of the first channel and a second determined value of a second higher layer parameter for a second CORESET of the second channel; and
determine another resource of the first resource and the second resource as a de-prioritized resource in the case that one prioritized resource is determined.

8. The UE of claim 7, wherein at least one prioritized resource includes at least one of:
a resource used by a channel of the first channel and the second channel having a priority level higher than other channel of the first channel and the second channel;
a resource used by a channel of the first channel and the second channel having a priority level lower than other channel of the first channel and the second channel in the case that the rule indicates simultaneous transmission of the first channel and the second channel is allowed;
a resource associated with a value of the first determined value and the second determined value that is higher than other value of the first determined value and the second determined value; or
a resource associated with a value of the first determined value and the second determined value that is lower than other value of the first determined value and the second determined value in the case that the rule indicates simultaneous transmission of the first channel and the second channel is allowed.

9. The UE of claim 7, wherein a part of the de-prioritized resource overlapped with the prioritized resource or the de-prioritized resource is dropped, and the de-prioritized resource is not compared in following resource collisions.

10. The UE of claim 1, wherein in response to there being at least one resource collision in the set of resources, the at least one processor is further configured to cause the UE to:
determine a resource of the set of resources which is associated with a channel with a priority equal to or higher than any channel associated with other resources of the set of resources as a prioritized resource.

1. The UE of claim 1, wherein in a case that there being more than one resource collision in the set of resources, the at least one processor is further configured to cause the UE to:
determine a first prioritized resource from the set of resources firstly; and
determine a second prioritized resource from remaining resources of the set of resources, which is at least one of:
according to the first prioritized resource, a previous prioritized resource, or UE implementation;
based on a rule indicating simultaneous transmission of channels associated with different CORESET pool indexes; or
associated with a channel with a priority equal to or higher than any channel associated with the remaining resources of the set of resources.

12. The UE of claim 1, wherein in a case that there is a resource collision between a first resource used by a first channel of the plurality of channels and a second resource used by a second channel of the plurality of channels, and the first channel and the second channel have an identical priority level, the at least one processor is further configured to cause the UE to:
determine a prioritized resource of the first resource and the second resource based on at least one of:
a first remaining packet delay budget (PDB) of data associated with the first resource and a second remaining PDB of data associated with the second resource; or
a priority level of a flow carried on the first channel and a priority level of a flow carried on the second channel.

13. The UE of claim 1, wherein to determine whether there is one or more resource collisions comprises:
to determine there is a resource collision in a case that UE capability is limited.

14. A base station (BS), comprising:
at least one memory; and
at least one processor coupled with the at least one memory and configured to cause the BS to:
determine whether there is one or more resource collisions among a set of resources used by a plurality of channels, wherein the plurality of channels are associated with different control resource set (CORESET) pool indexes; and
determine one or more resource of the set of resources as one or more prioritized resources in response to there is one or more resource collisions.

15. A method performed by a user equipment (UE), comprising:
determining whether there is one or more resource collisions among a set of resources used by a plurality of channels, wherein the plurality of channels are associated with different control resource set (CORESET) pool indexes; and
determining one or more resources of the set of resources as one or more prioritized resources in response to there being one or more resource collisions.

16. A processor for wireless communication, comprising:
at least one controller coupled with at least one memory and configured to cause the processor to:
determine whether there are one or more resource collisions among a set of resources used by a plurality of channels, wherein the plurality of channels are associated with different control resource set (CORESET) pool indexes; and
determine one or more resources of the set of resources as one or more prioritized resources in response to there being one or more resource collisions.

17. The processor of claim 16, wherein to determine whether there are one or more resource collisions, the at least one controller is configured to cause the processor to:
determine, for a first resource used by a first channel of the plurality of channels and a second resource used by a second channel of the plurality of channels, whether the first resource and the second resource at least partially overlap in at least one of time domain or frequency domain, wherein a CORESET pool index associated with the first channel is different from that associated with the second channel.

18. The processor of claim 17, wherein in a case that the first resource and the second resource at least partially overlap in at least one of time domain or frequency domain, the at least one controller is further configured to cause the processor to:
determine there is no resource collision between the first resource and the second resource in response to at least one of:
the first channel and the second channel being allowed to be transmitted simultaneously;
the first channel and the second channel being a same type of channel; or
an updated code rate of uplink data for a punctured channel of the first channel and the second channel being smaller than a threshold.

19. The processor of claim 16, wherein in a case that there is a resource collision between a first resource used by a first channel of the plurality of channels and a second resource used by a second channel of the plurality of channels, the at least one controller is further configured to cause the processor to:
determine at least one prioritized resource from the first resource and the second resource based on at least one of:
a first priority level of the first channel and a second priority level of the second channel;
a rule indicating simultaneous transmission of channels associated with different CORESET pool indexes; or
a first determined value of a first higher layer parameter for a first CORESET of the first channel and a second determined value of a second higher layer parameter for a second CORESET of the second channel; and
determine another resource of the first resource and the second resource as a de-prioritized resource in the case that one prioritized resource is determined.

20. The processor of claim 19, wherein a part of the de-prioritized resource overlapped with the prioritized resource or the de-prioritized resource is dropped, and the de-prioritized resource is not compared in following resource collisions.
